(19) United States
(12) Patent Application Publication
(10) Pub. No.: US 2015/0161509 A1
(43) Pub. Date: Jun. 11, 2015

(54) SETTING SUPPORT DEVICE, AND SETTING SUPPORT METHOD

(71) Applicant: FUJITSU LIMITED, Kawasaki-shi (JP)

(72) Inventors: Tetsuya Uchiumi, Kawasaki (JP); Shinya Kitajima, Inagi (JP); Shinji Kikuchi, Yokohama (JP); Yasuhide Matsumoto, Kawasaki (JP)

(21) Appl. No.: 14/548,711

(22) Filed: Nov. 20, 2014

(30) Foreign Application Priority Data
Dec. 5, 2013 (JP) 2013-252542

(51) Int. Cl. G06N 5/02; G06F 17/30

(52) U.S. Cl. CPC G06N 5/025; G06F 17/30598

(57) ABSTRACT

In a setting support device, for the existing system groups each include multiple tags, a grouping unit groups the systems that have common tags. A rule extracting unit extracts, for each grouped group, a set rule that is used for environmental setting set in each of the systems on the basis of the environmental setting that is set in the systems belonging to a group. A tag common rule specifying unit specifies a set rule that is common in each tag on the basis of the set rule that is extracted for each group and on the basis of the tags included in the systems belonging to each group. A new rule merging unit creates, by using the set rule specified by each tag, a set rule that is associated with the multiple tags included in a new system.

### CROSS-REFERENCE TO RELATED APPLICATION(S)

This application is based upon and claims the benefit of priority of the prior Japanese Patent Application No. 2013-252542, filed on Dec. 5, 2013, the entire contents of which are incorporated herein by reference.

### FIELD

The embodiment discussed herein is related to a setting support device, and a setting support method.

### BACKGROUND

In recent years, cloud systems in which multiple computing resources on networks can be used as the computing resources of users are used by using the virtualization technology of servers or networks. The cloud systems become large and complicated and, furthermore, sometimes provide a new system.

When a new system is provided, the system is designed. In the system design, for example, a designer creates a design rule and a design procedure. The design rule mentioned here is the rule in which the parameter related to the design is set and the design procedure mentioned here is the list of design rules arranged in operation order. Then, a device that automatically creates a parameter creates, on the basis of the created design rule and the design procedure, a parameter related to a system that is to be changed.

Furthermore, there is a technology that supports, when a new system is provided, a selection of the optimum system configuration for the performance of the network when the system is operated. For example, a support server collects, from an infrastructure DB of a management support target network, configuration information, performance information, or the like and stores the information in a system DB. The support server acquires, from the system DB, the configuration information and the performance information and then creates, by using a learning method, such as a decision tree method, a classification rule in which the configuration information is classified on the basis of the characteristic performance information obtained during the operation. Then, the support server extracts, for each server on the basis of the classification rule, the performance information that is a bottleneck with respect to the needed performance condition of at least one of the running servers installed in the system.

Patent Document 1: International Publication Pamphlet No. WO 2007/060721

Patent Document 2: Japanese Laid-open Patent Publication No. 2006-65706

Patent Document 3: Japanese Laid-open Patent Publication No. 2002-358200

Patent Document 4: Japanese Laid-open Patent Publication No. 09-212353

Patent Document 5: Japanese Laid-open Patent Publication No. 07-225679

Patent Document 6: Japanese Laid-open Patent Publication No. 09-128021

However, when a new system is provided and the same system as an existing system is provided, a new system can be constructed by storing a design rule or a design procedure that can be used in the existing system. However, because the same system as the existing system is hardly provided, there is a problem in that it is difficult to automatically design a system that is not the same as the existing system. Namely, it is difficult to automatically create a design rule or a design procedure of a new system that is not the same as the existing system.

Even if a technology that supports a selection of the optimum system configuration for the performance of the network when the system is operated, a support server extracts, for each server, performance information on a new system; however, with this technology, a design rule or a design procedure of the new system is not able to be automatically created.

### SUMMARY

According to an aspect of an embodiment, a non-transitory computer-readable recording medium stores therein a setting support program that causes a computer to execute a process. The process includes grouping, for a first system that includes multiple attributes, systems that have common attributes. The process includes extracting, for each group grouped at the grouping, a set rule that is used for environmental setting set in each of the systems on the basis of the environmental setting set in each of the systems belonging to a group. The process includes specifying a set rule that is common in each attribute on the basis of the set rule that is extracted for each group at the extracting and on the basis of the attributes included in the systems belonging to each group. The process includes creating, by using the set rule that is specified for each attribute at the specifying, a set rule that is associated with multiple attributes included in a second system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of a setting support device according to an embodiment;

FIG. 2 is a schematic diagram illustrating an example of the data structure of a tag information table;

FIG. 3A is a schematic diagram (1) illustrating an example of the data structure of teacher data;

FIG. 3B is a schematic diagram (2) illustrating an example of the data structure of the teacher data;

FIG. 4 is a schematic diagram illustrating grouping performed by a grouping unit;

FIG. 5A is a schematic diagram (1) illustrating rule extraction performed by a rule extracting unit;

FIG. 5B is a schematic diagram (2) illustrating the rule extraction performed by the rule extracting unit;

FIG. 5C is a schematic diagram (3) illustrating the rule extraction performed by the rule extracting unit;

FIG. 6A is a schematic diagram (1) illustrating a process of specifying a tag common rule performed by a tag common rule specifying unit;

FIG. 6B is a schematic diagram (2) illustrating the process of specifying a tag common rule performed by the tag common rule specifying unit;

FIG. 6C is a schematic diagram (3) illustrating the process of specifying a tag common rule performed by the tag common rule specifying unit;

FIG. 6D is a schematic diagram (4) illustrating the process of specifying a tag common rule performed by the tag common rule specifying unit;

FIG. 6E is a schematic diagram (5) illustrating the process of specifying a tag common rule performed by the tag common rule specifying unit;

FIG. 6F is a schematic diagram (6) illustrating the process of specifying a tag common rule performed by the tag common rule specifying unit;

FIG. 6G is a schematic diagram (7) illustrating the process of specifying a tag common rule performed by the tag common rule specifying unit;

FIG. 7A is a schematic diagram (1) illustrating a process of merging a new rule performed by a new rule merging unit;

FIG. 7B is a schematic diagram (2) illustrating the process of merging a new rule performed by the new rule merging unit;

FIG. 8 is a schematic diagram illustrating a process of creating recommended setting performed by a recommended setting creating unit;

FIG. 9 is a flowchart illustrating the flow of a setting support process according to the embodiment; and

FIG. 10 is a schematic diagram illustrating an example of a computer that executes a setting support program.

### DESCRIPTION OF EMBODIMENTS

Preferred embodiments of the present invention will be explained with reference to accompanying drawings.

The present invention is not limited to the embodiment.

Configuration of a Setting Support Device

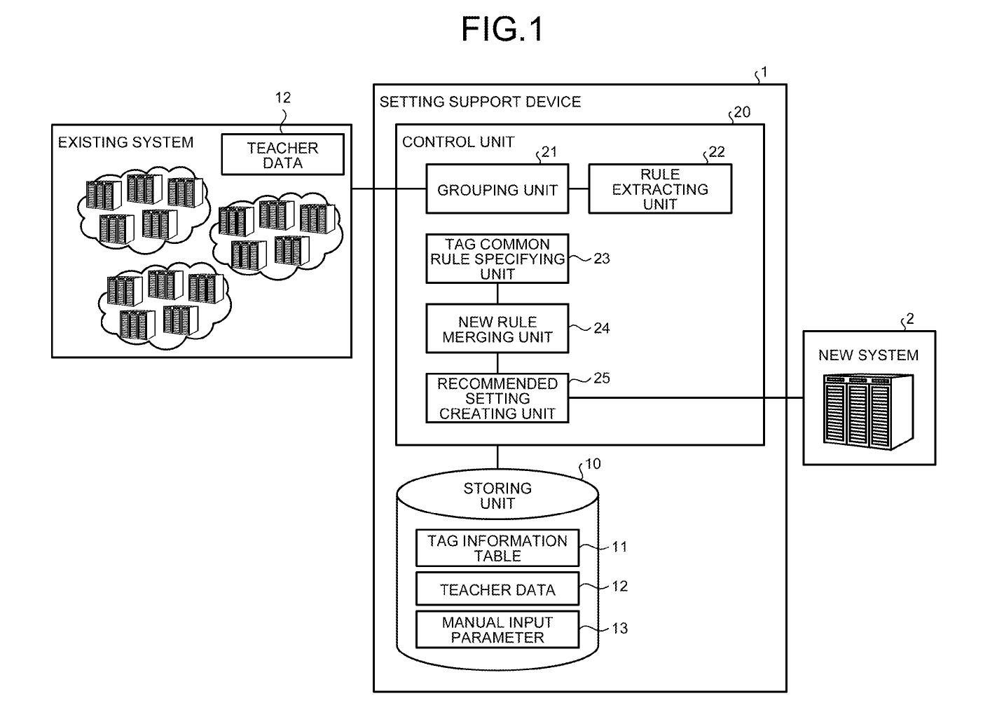

FIG. 1 is a functional block diagram illustrating the configuration of a setting support device according to an embodiment. A setting support device 1 supports the setting of the parameter that is used when an environment of a system is designed. For example, when a system is newly constructed in a cloud system, the setting support device 1 automatically sets a value of the parameter even if the feature of the system is different from a running existing system. By using set information, i.e., teacher data 12, which will be described later, related to the parameter of the existing system and by using a tag that is used to characterize each system, the setting support device 1 creates a design rule or a design procedure that are used for the setting of the parameter of a new system 2. Then, by using the created design rule or the design procedure, the setting support device 1 automatically sets a value of the parameter of the new system 2.

The tag mentioned here indicates the feature (index) of systems that can be used when the systems are grouped. An example of the tag includes an operating system (OS) used in a system; the performance level, such as high, medium, or low, in a system; the size of a system; or the like. The size of the system mentioned here indicates the size of a system that corresponds to the number of servers installed in the system and indicates the size of the system obtained when the total size of all of the servers installed in the system is defined as one. The total size of all of the servers installed in the system is, for example, 128. If the number of the servers in a certain system is 64, the size of the system is defined as 1/2. Furthermore, the tag is an example of an attribute.

The design rule is the rule for the setting of the parameter that is related to the design of the system and is constituted from the condition and the definition. The design procedure is obtained by aligning the design rules in the order they are executed. Then, on the basis of the created design rules and the design procedure, the setting support device 1 sets a value of the parameter of the new system 2. The design rule is an example of the set rule.

As illustrated in FIG. 1, the setting support device 1 includes a storing unit 10 and a control unit 20.

The storing unit 10 is a storage device corresponding to a nonvolatile semiconductor memory device, such as a flash memory, a ferroelectric random access memory (FRAM) (registered trademark), and the like. The storing unit 10 includes a tag information table 11, the teacher data 12, and a manual input parameter 13.

The tag information table 11 stores therein tag information that is information on a tag that indicates the feature for each existing system. The tag information table 11 is stored in the storing unit 10 in advance by a designer. Furthermore, the number of tags stored in the tag information table 11 is assumed to be the number that can be managed by the designer.

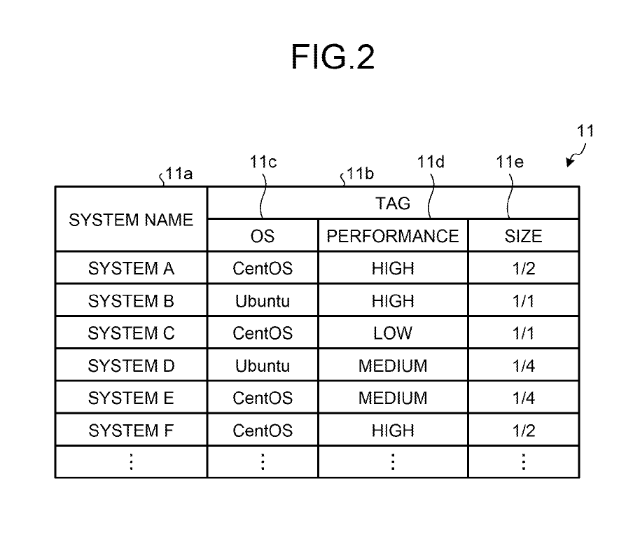

In the following, an example of the data structure of the tag information table 11 will be described with reference to FIG. 2. FIG. 2 is a schematic diagram illustrating an example of the data structure of a tag information table. As illustrated in FIG. 2, the tag information table 11 stores therein, in an associated manner, a system name 11a and a tag 11b. In the tag 11b, for example, an OS 11c, a performance 11d, and a size 11e are stored. The system name 11a indicates the name of an existing system. The OS 11c indicates the name of an OS that is used by the system indicated by the system name 11a. The performance 11d indicates the performance level, such as high, medium, or low, of the system that is indicated by the system name 11a. The size 11e indicates the size of the system that is indicated by the system name 11a. For example, if the system name 11a is “system A”, “CentOS” is stored as the OS 11c, “high” is stored as the performance 11d, and “1/2” is stored as the size 11e.

A description will be given here by referring back to FIG. 1. The teacher data 12 is the set information related to the parameter in an existing system and is stored in the storing unit 10 by a grouping unit 21, which will be described later.

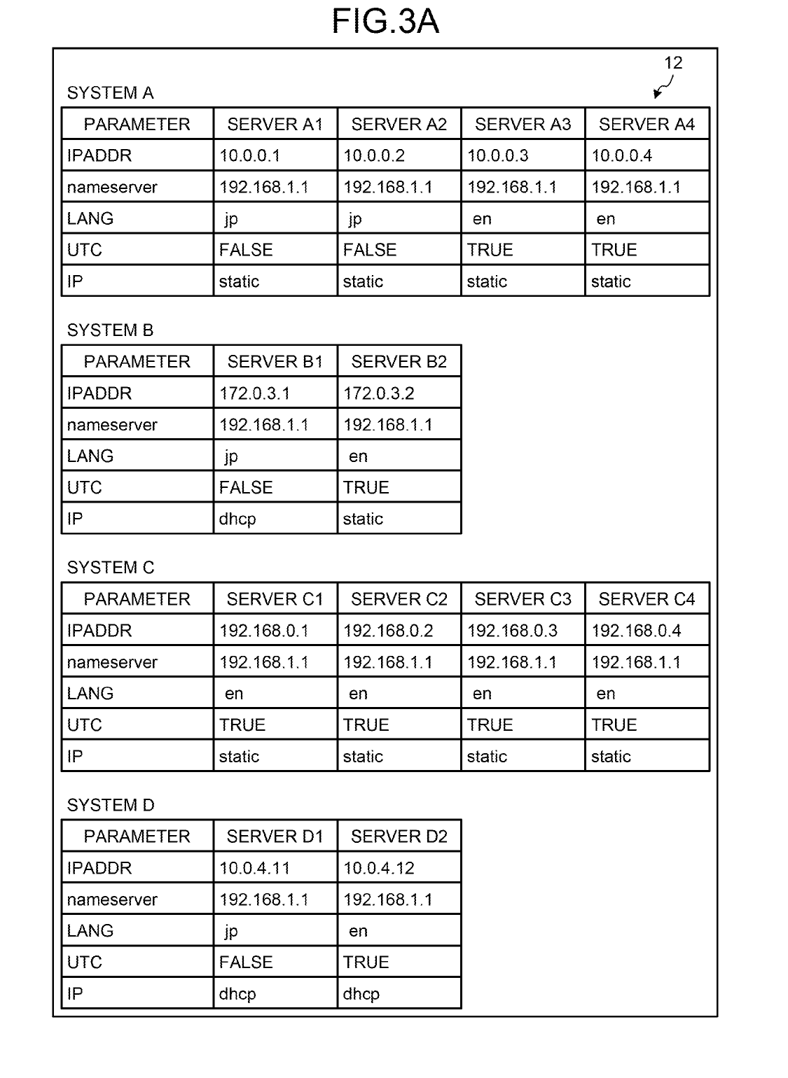

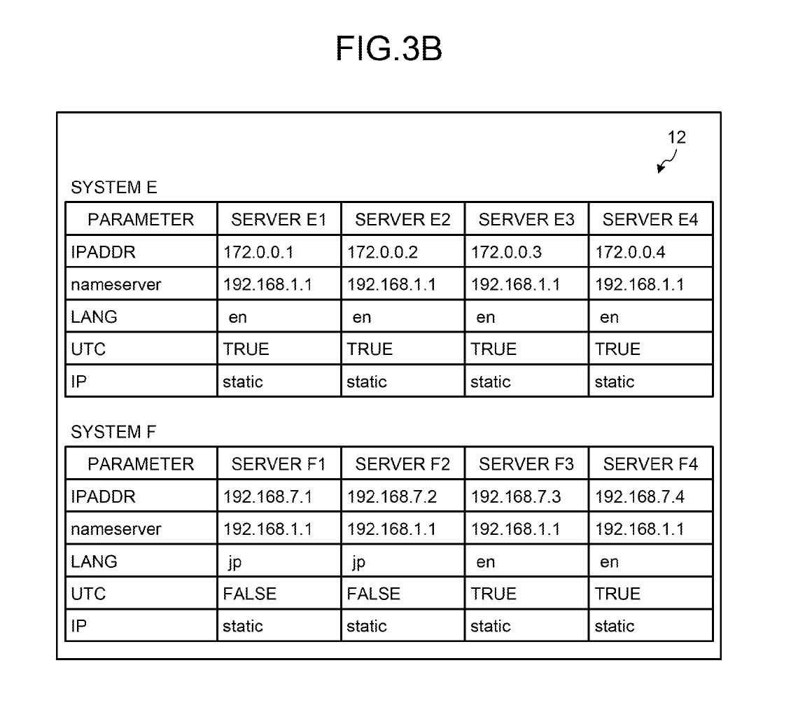

In the following, an example of the data structure of the teacher data 12 for each existing system will be described with reference to FIGS. 3A and 3B. FIGS. 3A and 3B are schematic diagrams each illustrating an example of the data structure of teacher data. For example, as illustrated in FIG. 3A, the teacher data 12 related to a system A stores therein, in an associated manner, a parameter, a server A1, a server A2, a server A3, and a server A4.

The server A1, the server A2, the server A3, and the server A4 are the name of the servers installed in an existing system A. In this example, four servers are installed; however, the number of servers to be installed varies in accordance with the size that is defined by the design of the system.

The parameter mentioned here is the parameter that is used when a system is designed. In this example, “IPADDR”, “nameserver”, “LANG”, “UTC”, and “IP” are included in the parameter. The “IPADDR” indicates the IP address of a server. The “nameserver” indicates the IP address of the domain name service (DNS). The “LANG” indicates the use language of the server. The “UTC” indicates whether the coordinated universal time is used. For example, if “true” is used, the coordinated universal time is used and, if “false” is used, the coordinated universal time is not used. The “IP” indicates whether the IP address is dynamically allocated or statically allocated. For example, if “dhcp” is used, the IP address is dynamically allocated and, if “static” is used, the IP address is statically allocated.

In each of the servers, the values of these parameters are set. For example, in a case of the server A1, “10.0.0.1” is set to the parameter “IPADDR” and “192.168.1.1” is set to the parameter “nameserver”. Furthermore, “jp” is set to the parameter “LANG”, “FALSE” is set to the parameter “UTC”, and “static” is set to the parameter “IP”. As illustrated in FIGS. 3A and 3B, for systems B to F, similarly to the system A, the teacher data 12 is stored in the storing unit 10.

A description will be given here by referring back to FIG. 1. The manual input parameter 13 is a parameter in which a value is set by a manual input and is stored in the storing unit 10 by a rule extracting unit 22 and a new rule merging unit 24, which will be described later.

A description will be given here by referring back to FIG. 1. The control unit 20 includes an internal memory that stores therein control data and programs that prescribe various kinds of procedures, whereby various kinds of processes are executed. Furthermore, the control unit 20 corresponds to an electronic circuit in an integrated circuit, such as an application specific integrated circuit (ASIC), a field programmable gate array (FPGA), and the like. Alternatively, the control unit 20 corresponds to an electronic circuit, such as a central processing unit (CPU), a micro processing unit (MPU), and the like. Furthermore, the control unit 20 includes the grouping unit 21, the rule extracting unit 22, a tag common rule specifying unit 23, the new rule merging unit 24, and a recommended setting creating unit 25. The grouping unit 21 is an example of a grouped unit. The rule extracting unit 22 is an example of an extracting unit. The tag common rule specifying unit 23 is an example of a specifying unit. The new rule merging unit 24 is an example of a creating unit.

For the existing system group that includes multiple tags, the grouping unit 21 groups systems that have the same tags. For example, on the basis of the tag information related to each of the existing systems stored in the tag information table 11, the grouping unit 21 groups the systems that have the same tag information as a single group.

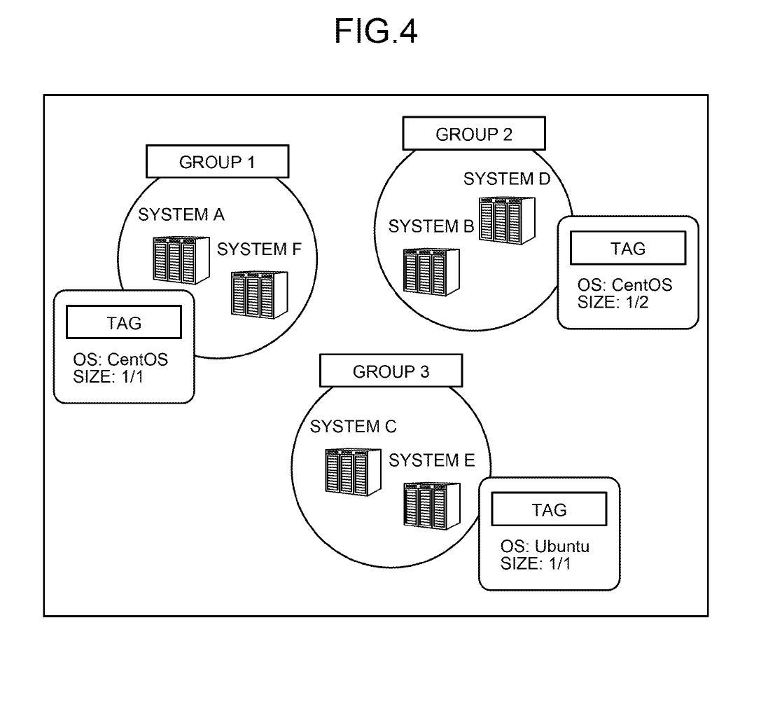

In the following, the grouping performed by the grouping unit 21 will be described with reference to FIG. 4. FIG. 4 is a schematic diagram illustrating grouping performed by a grouping unit. The tag information associated with the existing systems A to F is stored in the tag information table 11. In the tag information associated with each of the systems A and F, information indicating that the OS 11c is “CentOS” and the size 11e is “1/1” is stored. In the tag information associated with each of the systems B and D, information indicating that the OS 11c is “CentOS” and the size 11e is “1/2” is stored. In the tag information associated with each of the systems C and E, information indicating that the OS 11c is “Ubuntu” and the size 11e is “1/1” is stored.

As illustrated in FIG. 4, on the basis of the tag information stored in the tag information table 11, the grouping unit 21 groups the systems that have the same tag information. In this example, the grouping unit 21 groups the systems A and F that have the same tag information as a group 1. The grouping unit 21 groups the systems B and D that have the same tag information as a group 2. The grouping unit 21 groups the systems C and E that have the same tag information as a group 3.

A description will be given here by referring back to FIG. 1. The rule extracting unit 22 extracts, for each group that is grouped by the grouping unit 21, a design rule that is used by the setting of the parameter of an existing system on the basis of the setting of the environmental setting that is set in the system belonging to the group. For example, by using a clustering method, the rule extracting unit 22 specifies, for each group that is grouped, the intersection of the systems from the teacher data 12 related to each of the multiple systems belonging to the group. Then, the rule extracting unit 22 extracts a design rule based on the result of the clustering. Any clustering method may be used for the clustering.

Furthermore, from among the parameters included in the teacher data 12, the rule extracting unit 22 specifies, for each group that has been grouped by the grouping unit 21, a parameter that is to be manually input. For example, the rule extracting unit 22 specifies, as a manual input parameter, the parameter that is uniquely held by all of the servers in each of the systems. This is because, if all of the servers have the parameter with a unique value, the rule extracting unit 22 is not able to set a value for the parameter by using the condition and the definition. Furthermore, the rule extracting unit 22 specifies the parameter that has a unique value from among the systems, i.e., the parameter that has a unique value for each of the systems, as a manual input parameter. This is because, if the parameter has a unique value from among the systems, the rule extracting unit 22 is not able to set a value for the parameter by using the condition and the definition. Then, the rule extracting unit 22 stores the manual input parameter in the manual input parameter 13 in the storing unit 10.

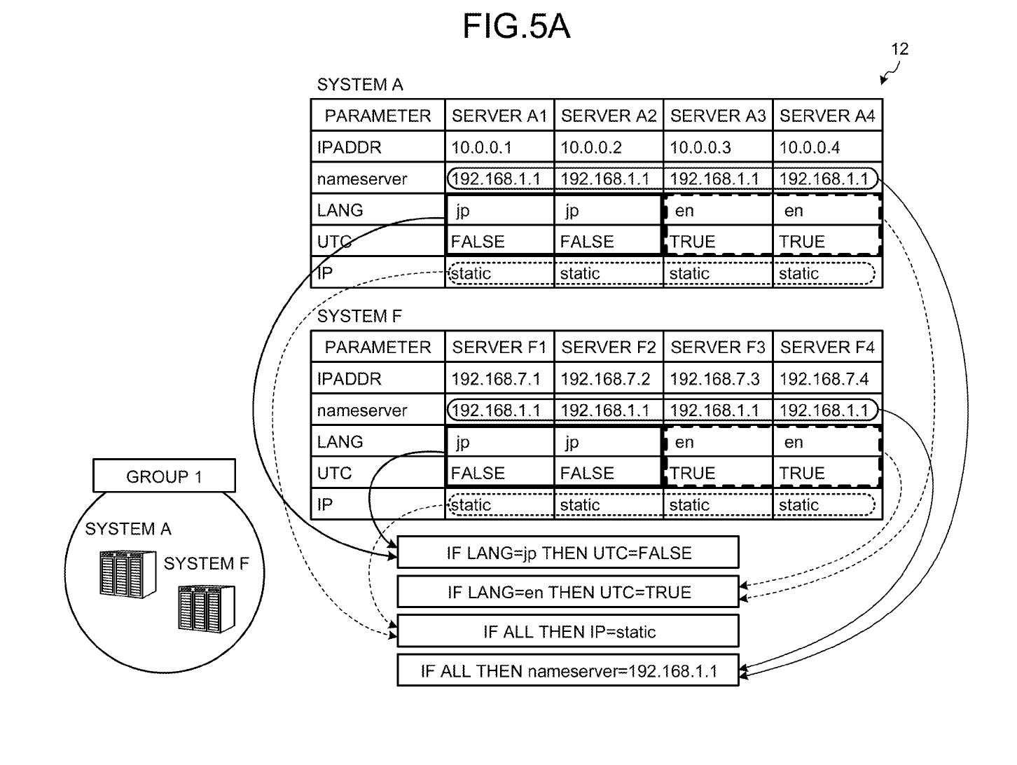

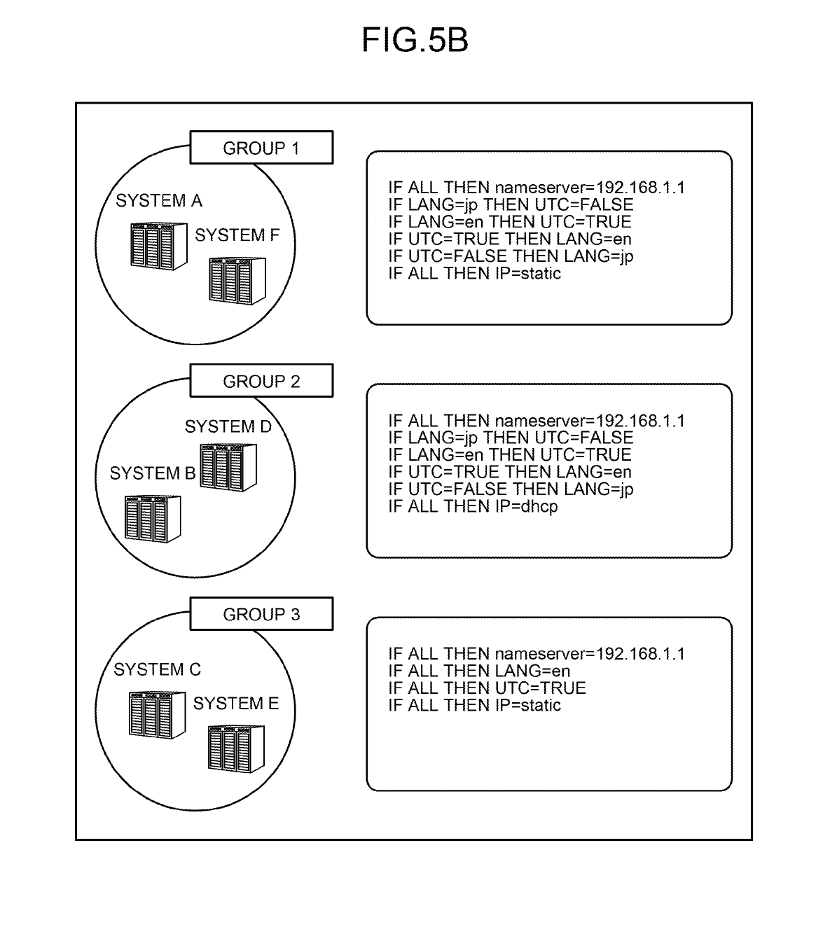

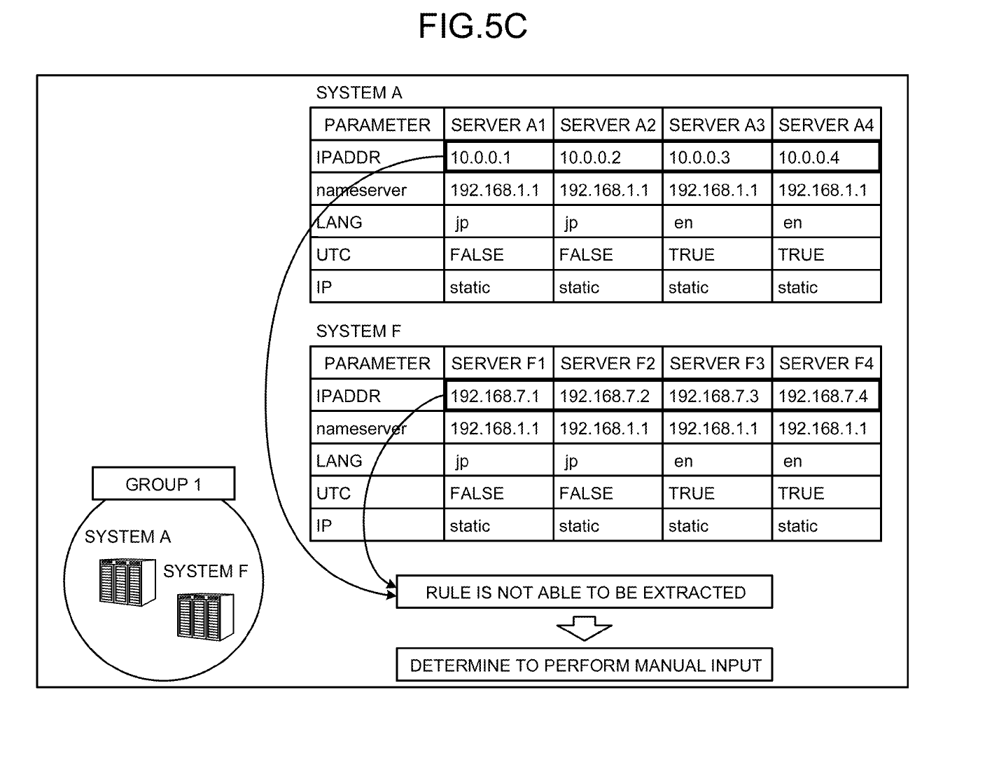

In the following, rule extraction performed by the rule extracting unit 22 will be described with reference to FIGS. 5A to 5C. FIGS. 5A to 5C are schematic diagrams each illustrating rule extraction performed by a rule extracting unit.

FIG. 5A illustrates the rule extraction performed on the systems A and F belonging to the group 1. The rule extracting unit 22 specifies, by using the clustering method, the intersection of the systems from the teacher data 12 in the systems A and F belonging to the group 1 that has been grouped. In this example, the rule extracting unit 22 specifies the value of the parameter “LANG” and the value of the parameter “UTC”, which are set for each server, as the intersection. Namely, in the systems A and F, if the parameter “LANG” is “jp”, the parameter “UTC” is “FALSE” and, if the parameter “LANG” is “en”, the parameter “UTC” is “TRUE”. Furthermore, the rule extracting unit 22 specifies the value of the parameter “nameserver”, which is set for each server, as the intersection. Namely, in the systems A and F, all of the values of the parameter “nameserver” are “192.168.1.1”. Furthermore, the rule extracting unit 22 specifies the value of the parameter “IP”, which is set for each server, as the intersection. Namely, in the systems A and F, all of the values of the parameter “IP” are “static”. The intersections described above are specified as the result of the clustering.

Then, the rule extracting unit 22 extracts a design rule from the result of the clustering. In this example, the rule extracting unit 22 extracts the design rules of “IF LANG=jp THEN UTC=FALSE” and “IF LANG=en THEN UTC=TRUE”. Furthermore, in the group 1, the rule extracting unit 22 extracts the design rules of “IF UTC=TRUE THEN LANG=en” and “IF UTC=FALSE THEN LANG=jp”. Furthermore, the rule extracting unit 22 extracts the design rule of “IF ALL THEN nameserver=192.168.1.1”. Furthermore, the rule extracting unit 22 extracts the design rule of “IF ALL THEN IP=static”.

As illustrated in FIG. 5B, the design rules extracted for each of the groups 1, 2, and 3 by the rule extracting unit 22 are indicated.

FIG. 5C illustrates a case in which the rule of the systems A and F belonging to the group 1 is not able to be extracted. The rule extracting unit 22 determines a unique value of the parameter that is held by all of the servers in each system as a manual input parameter. In this example, in the systems A and F, for the value of the parameter “IPADDR”, all of the servers have their value. Namely, the parameter “IPADDR” is the parameter that is held by all of the servers with a unique value. Consequently, the rule extracting unit 22 specifies “IPADDR” as a manual input parameter.

A description will be given here by referring back to FIG. 1. The tag common rule specifying unit 23 specifies a design rule that is common in for each tag on the basis of the design rule that has been extracted for each group by the rule extracting unit 22 and the tag that is held by the system belonging to each group. For example, the tag common rule specifying unit 23 specifies a tag that is common in groups. Then, the tag common rule specifying unit 23 compares the design rules in each group that has the specified tag and then specifies the common design rule.

Furthermore, on the basis of the design rule extracted for each group by the rule extracting unit 22, the tag common rule specifying unit 23 specifies a design rule (all common rule) that is common in all of the groups.

Furthermore, if the tag common rule specifying unit 23 is not able to specify a design rule that is common in the tag held by a single group, the tag common rule specifying unit 23 estimates a design rule that is common in the target tag. The case in which the design rule common in the tag held by a single group is not able to be specified indicates the case in which a tag held by a single group is not held by another group. The tag in which a design rule that is common in the tag held by a single is not able to be specified is referred to as “unspecified tag”. For example, it is assumed that the design rule of a group is constituted by the design rule that is common in each of the tags belonging to a group and the all common rule. With this assumption, the tag common rule specifying unit 23 estimates a design rule that is common in the unspecified tag on the basis of the design rule of a group that has the unspecified tag, on the basis of the design rule that is common in another tag held by that group, and on the basis of the all common rule.

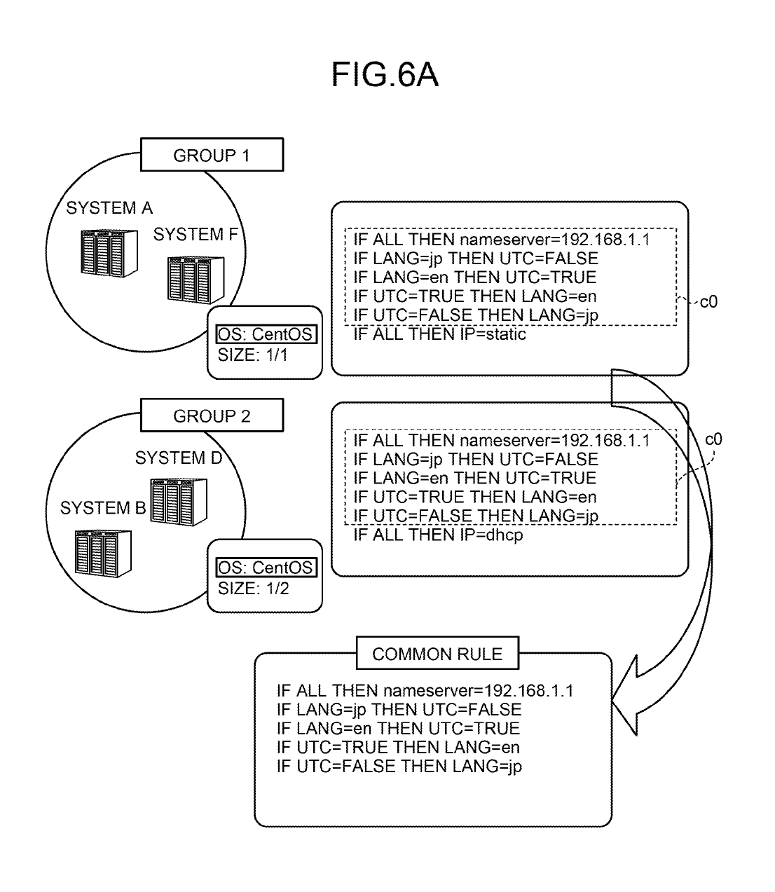

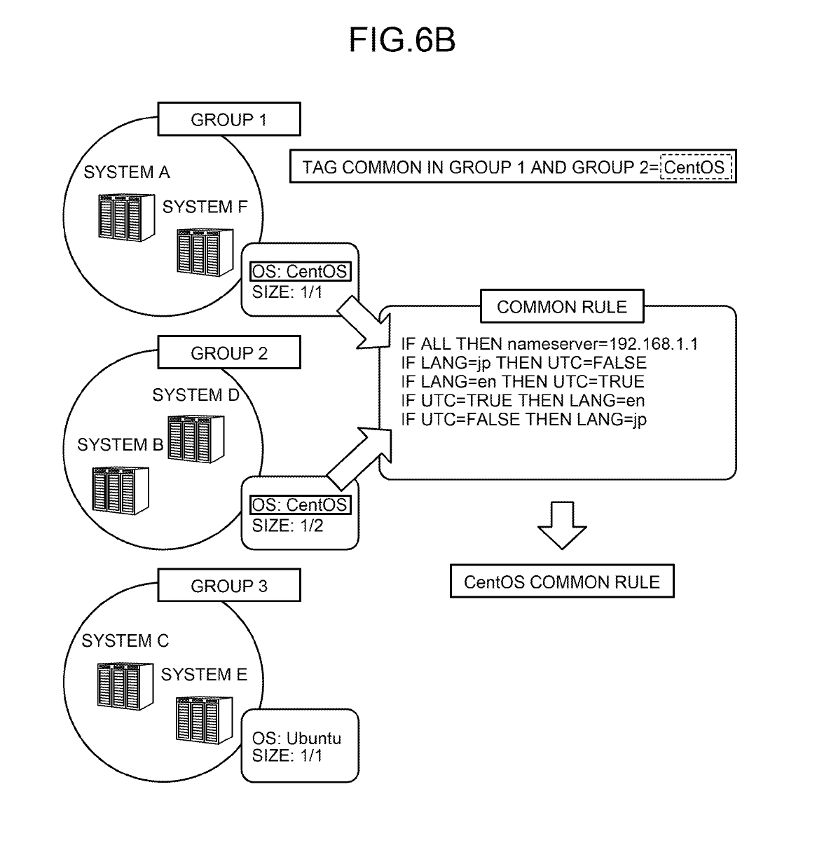

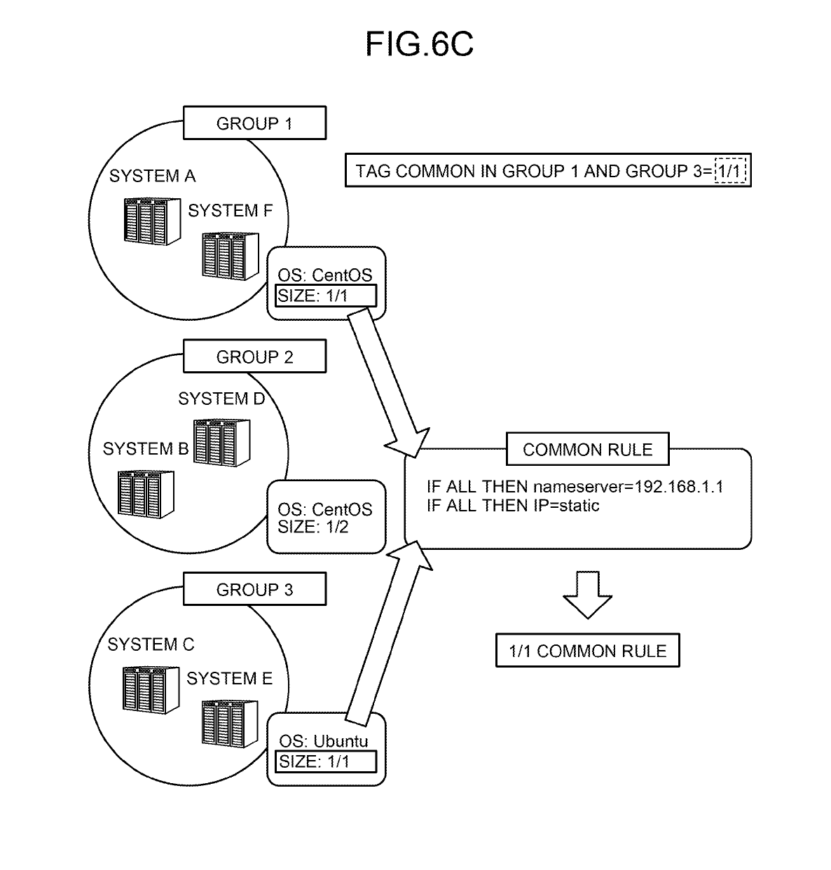

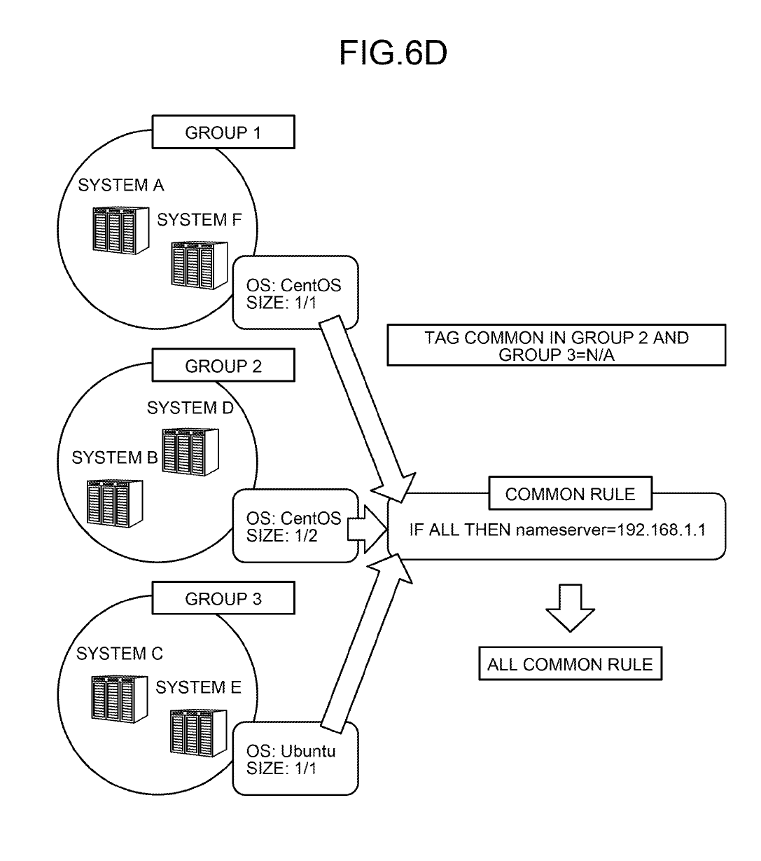

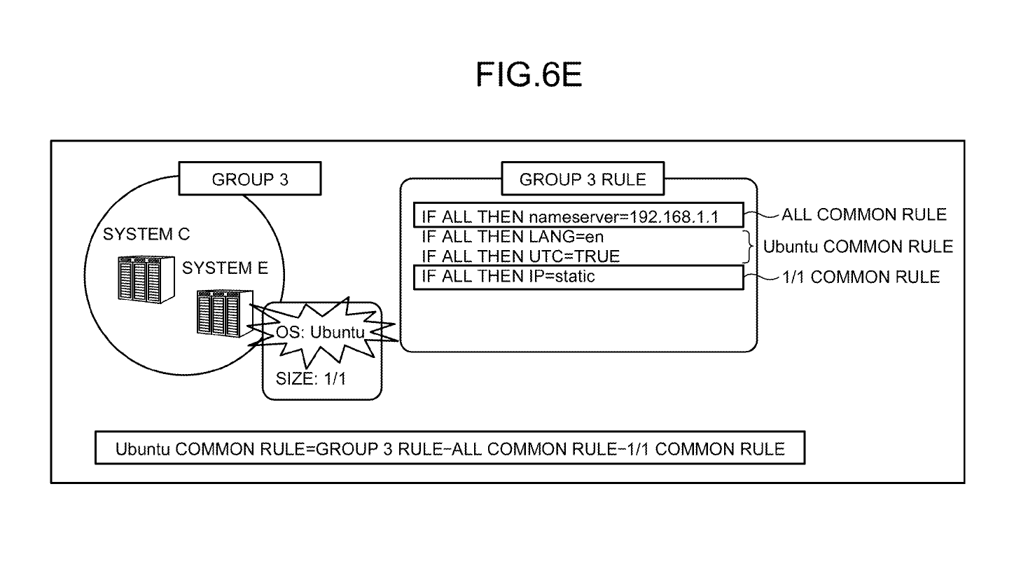

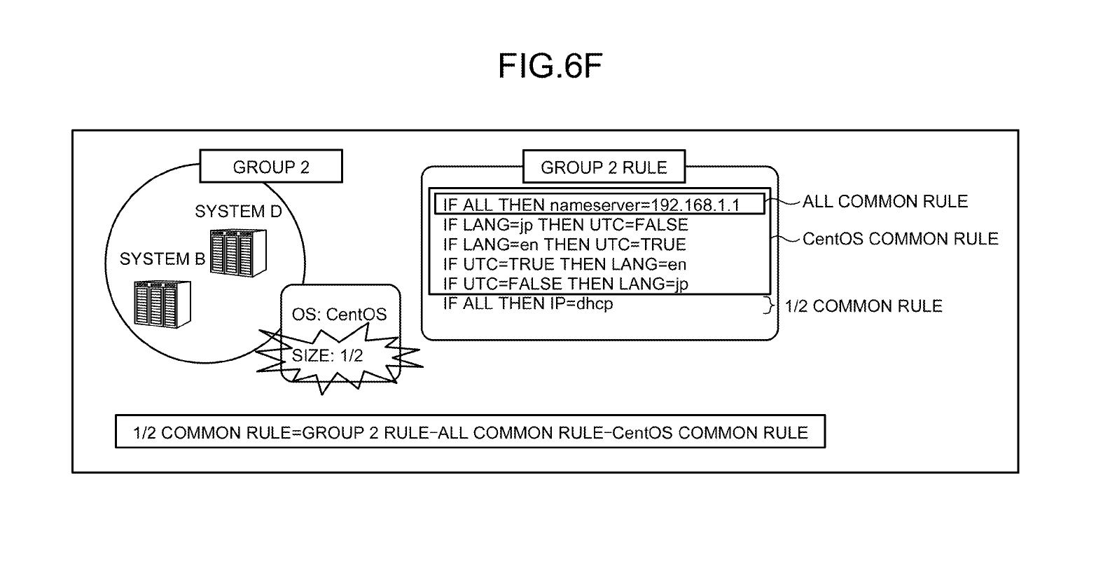

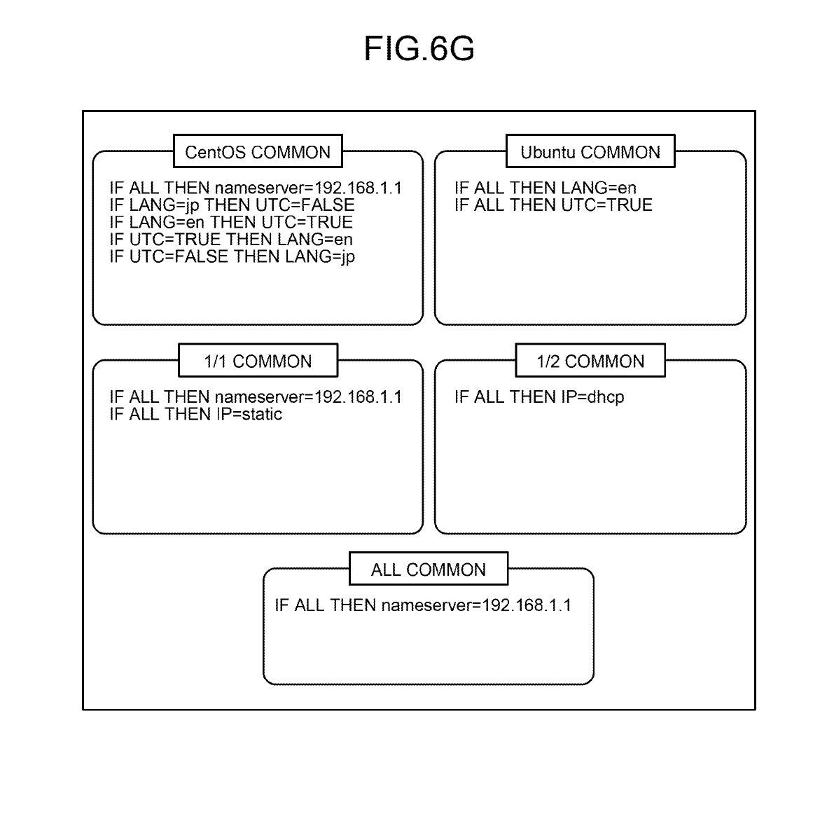

In the following, a process of specifying a tag common rule performed by the tag common rule specifying unit 23 will be described with reference to FIGS. 6A to 6G. FIGS. 6A to 6G are schematic diagrams each illustrating a process of specifying a tag common rule performed by a tag common rule specifying unit. It is assumed that the tag information associated with the systems A and F belonging to the group 1 is “CentOS” as the OS 11c and “1/1” as the size 11e. It is assumed that the tag information associated with the systems B and D belonging to the group 2 is “CentOS” as the OS 11c and “1/2” as the size 11e. It is assumed that the tag information associated with the systems C and E belonging to the group 3 is “Ubuntu” as the OS 11c and “1/1” as the size 11e. Furthermore, it is assumed that the unspecified tag is “Ubuntu” and “1/2”.

As illustrated in FIG. 6A, the design rule that is common in the tag “CentOS” in the groups 1 and 2 is specified. In this example, the tag common rule specifying unit 23 specifies tag “CentOS” that is common in the groups 1 and 2. Then, the tag common rule specifying unit 23 compares each of the design rules in the groups 1 and 2 that includes the specified tag “CentOS” and then specifies a design rule c0 that is in common.

Namely, as illustrated in FIG. 6B, the tag common rule specifying unit 23 specifies a tag that is common in the groups. In this example, the tag common rule specifying unit 23 specifies the tag “CentOS” that is common in the groups 1 and 2. Furthermore, because the tag of the OS 11c associated with the group 3 is “Ubuntu”, this tag is not common in the tag “CentOS” of the OS 11c in the groups 1 and 2. Then, the tag common rule specifying unit 23 compares each of the design rules of the groups 1 and 2 that include the specified tag “CentOS” and then specifies the common design rule. The specified design rule is defined as the common rule of “CentOS”.

As illustrated in FIG. 6C, the tag common rule specifying unit 23 specifies a tag that is common in groups. In this example, the tag common rule specifying unit 23 specifies tag “1/1” that is common in the groups 1 and 3. Because the tag indicated by the size 11e in the group 2 is “1/2”, this tag is not the same as the tag “1/1” indicated by the size 11e in the groups 1 and 3. Then, the tag common rule specifying unit 23 compares each of the design rules of the groups 1 and 3 that include the specified tag “1/1” and then specifies the common design rule. The specified design rule is defined as the common rule of 1/1.

As illustrated in FIG. 6D, the tag common rule specifying unit 23 specifies, on the basis of the design rule for each group, the design rule that is common in all of the groups. In this example, the tag common rule specifying unit 23 specifies “IF ALL THEN nameserver=192.168.1.1” as the design rule that is common in the groups 1, 2, and 3. The specified design rule is defined as the all common rule.

As illustrated in FIG. 6E, the design rule that is common in the unspecified tag “Ubuntu” is estimated. The tag information associated with the systems A and F belonging to the group 1 is “CentOS” as indicated by the OS 11c and the tag information associated with the systems B and D belonging to the group 2 is “CentOS” as indicated by the OS 11c. Furthermore, the tag information associated with the systems C and E belonging to the group 3 is “Ubuntu” as indicated by the OS 11c. Consequently, the tag common rule specifying unit 23 is not able to specify the design rule that is common in the tag “Ubuntu” included in the group 3. The tag “Ubuntu” is defined as the unspecified tag.

Accordingly, the tag common rule specifying unit 23 estimates a design rule that is common in the unspecified tag “Ubuntu” on the basis of the design rule in the group 3 that includes the unspecified tag, on the basis of the design rule that is common in the other tags included in the group 3, and on the basis of the all common rule. In this example, it is estimated that the design rule that is common in “Ubuntu” is obtained by excluding the all common rule and the design rule that is common in the other tag “1/1” included in the group 3 from the design rule in the group 3. Namely, the design rule that is common in “Ubuntu” is estimated to be “IF ALL THEN LANG=en” and “IF ALL THEN UTC=TRUE”. In this way, even if a tag in which a common design rule is not able to be specified is present, the tag common rule specifying unit 23 can estimate a design rule that is common in that tag.

As illustrated in FIG. 6F, the design rule that is common in the unspecified tag “1/2” is estimated. The tag information associated with the systems A and F belonging to the group 1 is “1/1” that is indicated by the size 11e and the tag information associated with the systems C and E belonging to the group 3 is “1/1” as indicated by the size 11e. Furthermore, the tag information associated with the systems B and D belonging to the group 2 is “1/2” as indicated by the size 11e. Consequently, the tag common rule specifying unit 23 is not able to the design rule that is common in the tag “1/2” in the group 2. The tag “1/2” is defined as the unspecified tag.

Accordingly, the tag common rule specifying unit 23 estimates the design rule that is common in the unspecified tag “1/2” on the basis of the design rule of the group 2 that includes the unspecified tag, on the basis of the design rule that is common in the other tags included in the group 2, and on the basis of the all common rule. In this example, it is estimated that the design rule that is common in “1/2” is obtained by excluding the all common rule and the design rule that is common in the other tag “CentOS” included in the group 2 from the design rule in the group 2. Namely, the design rule that is common in “1/2” is estimated to be “IF LANG=jp THEN UTC=FALSE” and “IF LANG=en THEN UTC=TRUE”. Furthermore, the design rule that is common in “1/2” is estimated to be “IF UTC=TRUE THEN LANG=en” and “IF UTC=FALSE THEN LANG=jp”. In this way, even if a tag in which a common design rule is not able to be specified is present, the tag common rule specifying unit 23 can estimate the design rule that is common in the tag.

As illustrated in FIG. 6G, the tag common rule specifying unit 23 can specify a common design rule for each tag included in each of the groups 1, 2, and 3 and the all common rule.

A description will be given here by referring back to FIG. 1. The new rule merging unit 24 creates design rules that are associated with multiple tags included in the new system 2 by using the design rule that is specified for each tag by the tag common rule specifying unit 23. For example, the new rule merging unit 24 acquires multiple tags included in the new system 2. The new rule merging unit 24 acquires, for example, multiple tags included in the new system 2 that is input by a designer. Then, the new rule merging unit 24 merges the design rules associated with each of the acquired tags and then creates the merged design rule as a design rule of the new system 2. The design rule created by being merged becomes a design procedure of, for example, the new system 2.

Furthermore, if a new tag is included in the multiple tags in the new system 2, the new rule merging unit 24 allows the setting of the parameter related to the new tag to be manually input. For example, the new rule merging unit 24 searches the multiple tags included in the new system 2 for a tag that is not included in the tag information that is stored in the tag information table 11. Then, if a tag that is not included in the tag information is present, the new rule merging unit 24 determines that the tag is a new tag. Then, the new rule merging unit 24 extracts the parameter that is related to the new tag on the basis of the design rule that is common in the tag with the same type as that of the new tag. For example, if a new tag “1/4” is searched as the size 11e, the new rule merging unit 24 extracts the parameter that is related to the size 11e on the basis of each of the common design rules common related to “1/1” and “1/2” that are included in the tag information as the same size 11e as that of the new tag “1/4”. It is estimated that the design rule that is common in the size 11e of “1/1” includes “IF ALL THEN IP=static”. It is estimated that the design rule that is common in the size 11e of “1/2” includes “IF ALL THEN IP=dhcp”. Then, the new rule merging unit 24 extracts the parameter related to the size 11e as the “IP” that is included in both the design rules. Then, the new rule merging unit 24 stores the parameter “IP” as the manual input parameter in the manual input parameter 13 in the storing unit 10. Consequently, even if a new tag is included in the multiple tags in the new system 2, the new rule merging unit 24 can support the designing performed by a designer by adding information to the manual input parameter 13.

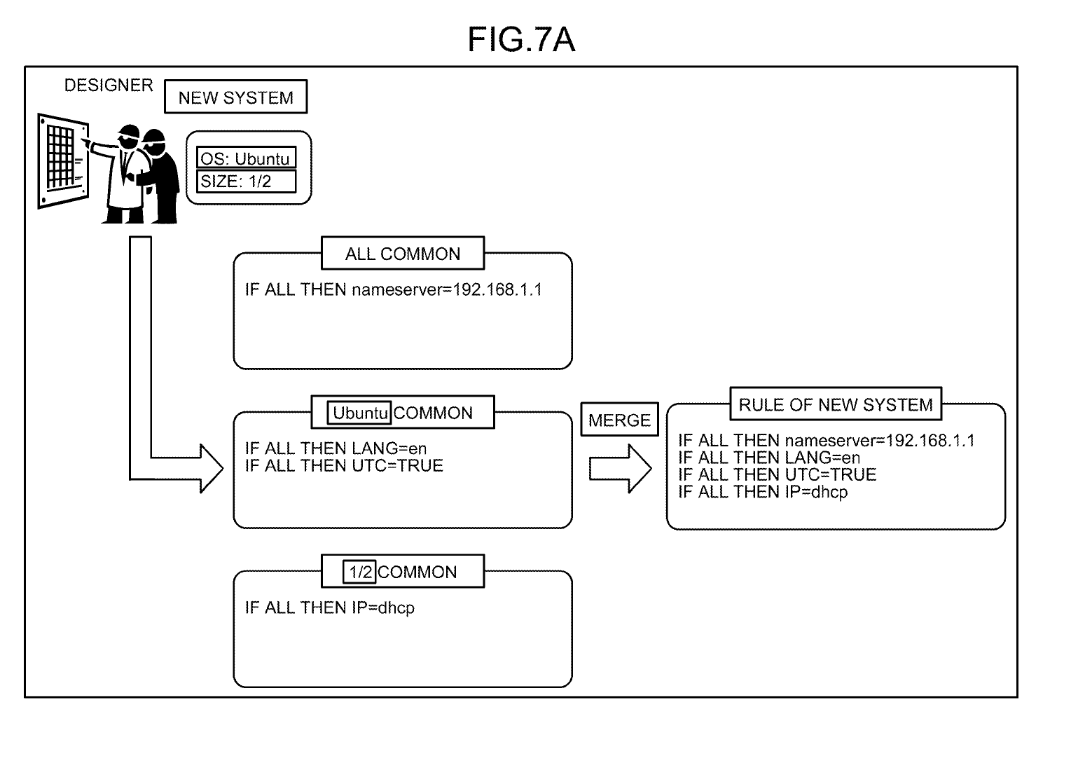

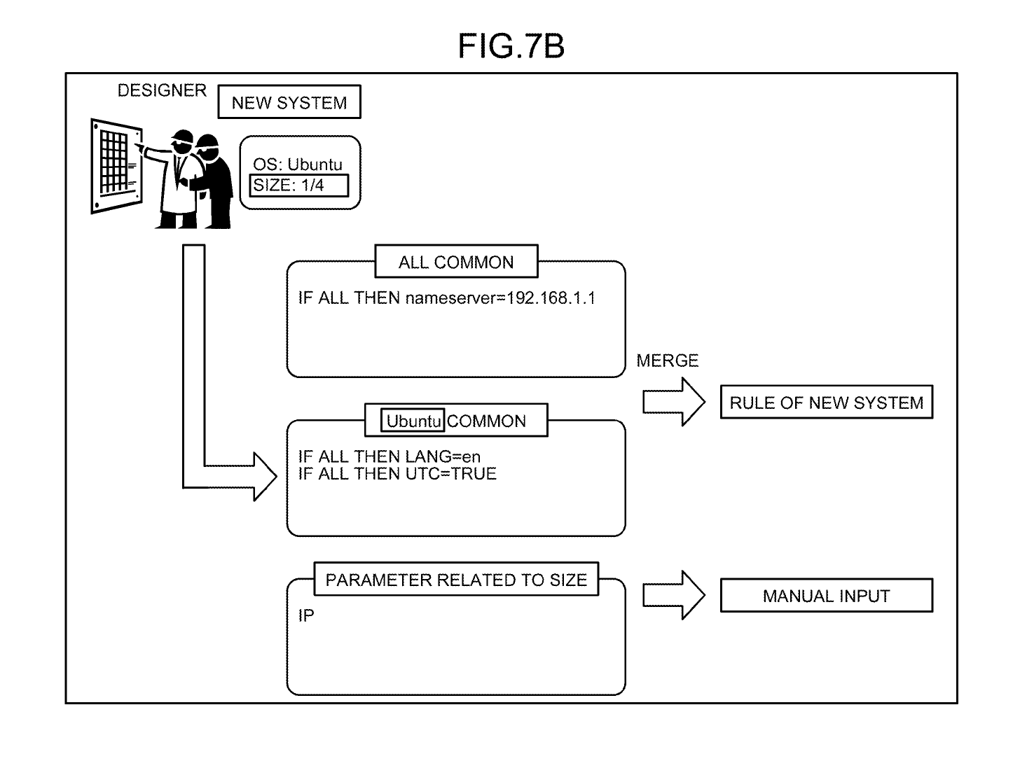

In the following, a process of merging new rules performed by the new rule merging unit 24 will be described with reference to FIGS. 7A and 7B. FIGS. 7A and 7B are schematic diagrams each illustrating a process of merging a new rule performed by a new rule merging unit. It is assumed that the all common rule, the design rule that is common in “Ubuntu” as the OS 11c, and the design rule that is common in “1/2” as the size 11e are specified by the tag common rule specifying unit 23.

As illustrated in FIG. 7A, multiple tags in the new system is input by a designer. In this example, “Ubuntu” is input as the OS 11c and “1/2” is input as the size 11e. Then, the new rule merging unit 24 merges the design rules associated with the tags. In this example, the new rule merging unit 24 merges the all common rule, the design rule that is common in “Ubuntu”, and the design rule that is common in “1/2”. Consequently, the new rule merging unit 24 creates the merged design rules as the design rules in the new system. The design rule created from the merging becomes the design procedure for the new system.

In the following, a description will be given of a case in which a new tag is included in multiple tags in the new system. As illustrated in FIG. 7B, multiple tags in the new system are input by the designer. In this example, “Ubuntu” is input as the OS 11c and “1/4” is input as the size 11e. Then, because there is no design rule that is common in “1/4”, the new rule merging unit 24 determines that “1/4” is a new tag as the size 11e. Then, on the basis of the design rules that are common in “1/1” and “1/2” included in the tag information as the size 11e, the new rule merging unit 24 extracts the parameter related to the size 11e. In this example, the new rule merging unit 24 extracts the parameter “IP” related to the size 11e. Accordingly, the new rule merging unit 24 merges the all common rule in which the design rules are common and the design rule that are common in “Ubuntu”. Consequently, the new rule merging unit 24 creates the merged design rule as the design rule in the new system. Furthermore, the new rule merging unit 24 sets the parameter “IP” related to the size 11e to the manual input. Then, the new rule merging unit 24 stores the parameter “IP” as the manual input parameter in the manual input parameter 13 in the storing unit 10.

A description will be given here by referring back to FIG. 1. In accordance with the design rule merged by the new rule merging unit 24, the recommended setting creating unit 25 creates a design value recommended for the parameter that is used to design the new system 2 that is target for the new design. For example, when the recommended setting creating unit 25 receives a manual input with respect to the manual input parameter stored in the manual input parameter 13, the recommended setting creating unit 25 creates a design value of the manual input parameter by using the received input data. Then, in accordance with the design rule (setting procedure) merged by the new rule merging unit 24, the recommended setting creating unit 25 sequentially creates a design value recommended by the parameter.

If a portion that is not created is present, the recommended setting creating unit 25 sends, to an administrator, a query about the manual input that is associated with the top parameter from among the portion that has not been created. An example of the portion that is not created includes a case in which a new server is additionally installed in the new system 2.

Furthermore, another example includes a case in which a new parameter that is to be set in the new system 2 is added. Furthermore, another example includes a case in which a setting policy of the new system 2 is changed.

Furthermore, the recommended setting creating unit 25 sets the created parameter in the new system 2.

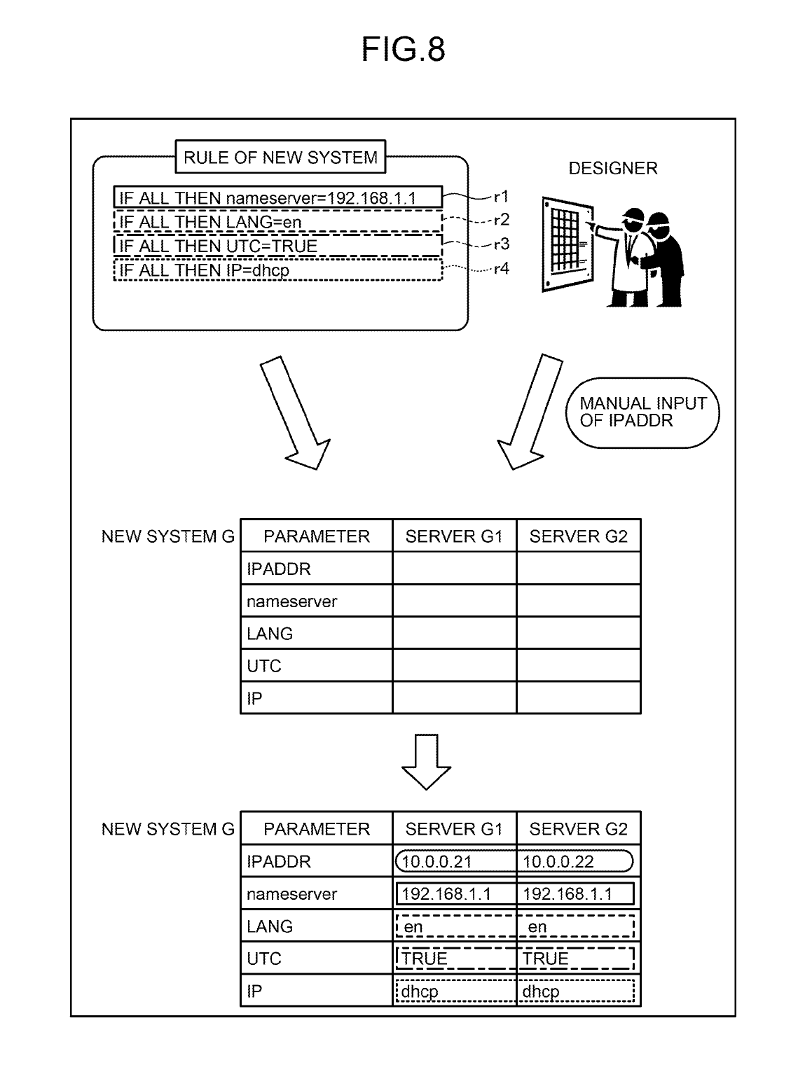

In the following, a process of creating recommended setting performed by the recommended setting creating unit 25 will be described with reference to FIG. 8. FIG. 8 is a schematic diagram illustrating a process of creating recommended setting performed by a recommended setting creating unit. It is assumed that the design rule (design procedure) for a new system G is created by the new rule merging unit 24.

Furthermore, “IPADDR” is stored as the manual input parameter in the manual input parameter 13.

As illustrated in the middle portion of FIG. 8, values of the parameters for the servers G1 and G2 installed in the new system G have not been created.

As illustrated in the lower portion of FIG. 8, when the recommended setting creating unit 25 receives a manual input with respect to the manual input parameter, the recommended setting creating unit 25 creates a design value of the manual input parameter. In this case, the value “10.0.0.21” that is input to the manual input parameter of “IPADDR” is allocated to the server G1. The value “10.0.0.22” that is input to the manual input parameter of “IPADDR” is allocated to the server G2.

Furthermore, the recommended setting creating unit 25 sequentially creates, in accordance with the design rule (design procedure), design values recommended for the parameter. In this example, in accordance with a design rule r1 of the new system, “192.168.1.1” is allocated to the parameter “nameserver” of each of the servers G1 and G2. Furthermore, in accordance with a design rule r2 of the new system, “en” is allocated to the parameter “LANG” of each of the servers G1 and G2. Furthermore, in accordance with a design rule r3 of the new system, “TRUE” is allocated to the parameter “UTC” of each of the servers G1 and G2. Furthermore, in accordance with a design rule r4 of the new system, “dhcp” is allocated to the parameter “IP” of each of the servers G1 and G2.

Consequently, if the new system G is added, the recommended setting creating unit 25 can create a design value recommended for the parameter in accordance with the design rule of the new system and can set the design value in the new system G.

Flow of a Setting Support Process

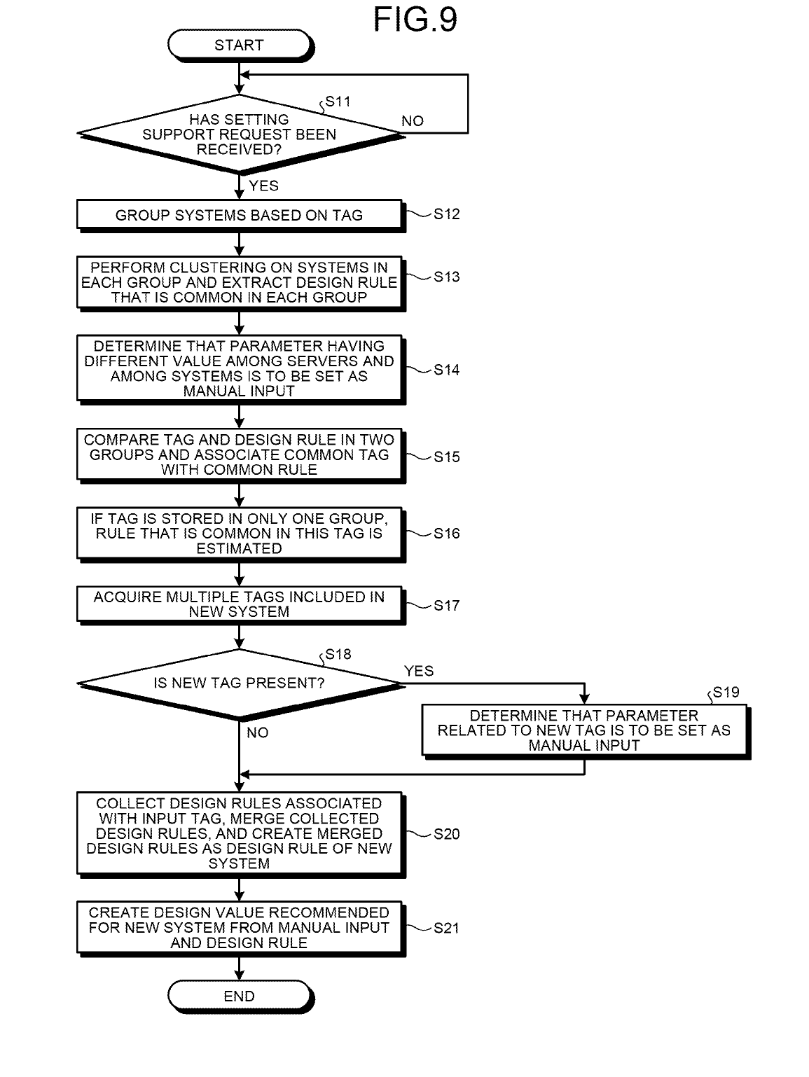

In the following, the flow of a setting support process will be described with reference to FIG. 9. FIG. 9 is a flowchart illustrating the flow of a setting support process according to the embodiment. The tag information associated with the multiple existing systems is stored in the tag information table 11 in advance.

First, the grouping unit 21 determines whether a setting support request for the new system 2 has been received (Step S11). If it is determined that a setting support request for the new system 2 has not been received (No at Step S11), the grouping unit 21 repeats the determining process until the setting support request is received.

In contrast, if it is determined that a setting support request for the new system 2 has been received (Yes Step S11), the grouping unit 21 groups the existing systems on the basis of the tag (Step S12). For example, on the basis of the tag information for each existing system stored in the tag information table 11, the grouping unit 21 groups the systems that have the same tag information.

Then, the rule extracting unit 22 performs the clustering on the systems in each group grouped by the grouping unit 21 and extracts the same design rule that is common in each group (Step S13). For example, by using the clustering method, the rule extracting unit 22 extracts, for each group, a design rule that is common in the groups from each of the teacher data 12 in the system that belongs to the group.

Then, the rule extracting unit 22 determines that the parameter that has a different value among the servers installed in the systems belonging to a group and among the systems belonging to the group is to be set as a manual input (Step S14). For example, the rule extracting unit 22 uses, as the manual input parameter, the parameter that is held as a unique value by all of the servers in each system belonging to a group. For another example, the rule extracting unit 22 uses, as the manual input parameter, the parameter that is held as a unique value by each system belonging to the group. Then, the rule extracting unit 22 stores the manual input parameter in the manual input parameter 13 in the storing unit 10.

Subsequently, the tag common rule specifying unit 23 compares the tag and the design rule in the two groups and associates the common tag with the common rule (Step S15). For example, the tag common rule specifying unit 23 specifies the tags that are common in the groups. Then, the tag common rule specifying unit 23 compares the design rules in the groups that include the specified tags and specifies a common design rule.

If the tag is a tag that is stored in only one group (unspecified tag), the tag common rule specifying unit 23 estimates a design rule that is common in this tag (Step S16). For example, the tag common rule specifying unit 23 estimates a design rule that is common in the unspecified tag on the basis of the design rule of the group that includes the unspecified tag, on the basis of the design rule that is common in another tag included in that group, and on the basis of the all common rule.

Then, the new rule merging unit 24 acquires multiple tags included in the new system 2 (Step S17). For example, the multiple tags included in the new system 2 are input by a designer. Then, the new rule merging unit 24 determines whether a new tag is present in the multiple tags that are included in the new system 2 (Step S18). For example, the new rule merging unit 24 determines whether a tag that is not included in the tag information stored in the tag information table 11 is present in the multiple tags included in the new system 2.

If it is determined that a new tag is not present (No at Step S18), the new rule merging unit 24 proceeds to Step S20.

In contrast, if it is determined that a new tag is present (Yes Step S18), the new rule merging unit 24 determines that the parameter related to the new tag is to be set as a manual input (Step S19). For example, the new rule merging unit 24 extracts the parameter related to the new tag on the basis of the design rule that is common in the same type tag as the new tag. Then, the new rule merging unit 24 stores the extracted parameter, as a manual input parameter, in the manual input parameter 13 in the storing unit 10. Then, the new rule merging unit 24 proceeds to Step S20.

At Step S20, the new rule merging unit 24 collects the design rules associated with the input tag, merges the collected design rules, and creates the merged design rules as the design rule of the new system 2 (Step S20).

Then, the recommended setting creating unit 25 creates a design value recommended for the new system 2 from both the manual input and the design rule merged by the new rule merging unit 24 (Step S21). For example, when the recommended setting creating unit 25 manually receives a design value for the manual input parameter that is stored in the manual input parameter 13, the recommended setting creating unit 25 creates information related to the manual input parameter by using the received design value. Then, the recommended setting creating unit 25 sequentially creates information related to the parameter in accordance with the design rule (design procedure) merged by the new rule merging unit 24.

### Advantage of the Embodiment

According to the embodiment, for the existing system groups each include multiple tags, the setting support device 1 groups the systems that have multiple common tags. Then, the setting support device 1 extracts, for each grouped group, a design rule that is used for environmental setting set in each of the systems. Then, the setting support device 1 specifies a design rule that is common in each tag on the basis of the design rule that has been extracted for each group and on the basis of the tags included in the systems belonging to each group. Then, by using the design rule specified for each tag, the setting support device 1 creates a design rule that is associated with the multiple tags included in the new system 2. With this configuration, the setting support device 1 can automatically create a design rule even if the feature (tag) of the new system 2 is different from that of the existing system. Namely, the setting support device 1 can support the construction of a system, i.e., the new system 2, even if the feature (tag) of the new system 2 is different from that of the existing system.

Furthermore, according to the embodiment, if a design rule that is common in predetermined tags is not specified, the setting support device 1 estimates a design rule that is common in the predetermined tags as follows. Namely, the setting support device 1 estimates a design rule that is common in predetermined tags on the basis of a design rule of the group that includes the predetermined tags, on the basis of a design rule that is common in another tag that is different from the predetermined tags included in that group, and on the basis of a design rule that is common in all of the groups. With this configuration, the setting support device 1 can easily estimate a design rule that is common in the predetermined tags even if the design rule that is common in the predetermined tags is not specified.

Furthermore, according to the embodiment, if a new tag is included in the multiple tags that are included in the new system 2, the setting support device 1 allows the environmental setting related to the new tag to be manually input. With this configuration, because the setting support device 1 allows the environmental setting related to the new tag to be manually input, the setting support device 1 can support the design performed by a designer.

Furthermore, according to the embodiment, the setting support device 1 extracts, for each grouped group, a design rule that indicates the condition and the definition used to set the parameters that is used for the environmental setting set in each of the systems. With this configuration, because the setting support device 1 extracts, for each grouped group, a design rule that is used to set the parameters, it is possible to extract an appropriate design rule from among the systems belonging to the same group.

Additional

Furthermore, the setting support device 1 can be implemented by installing the functions of units described above, such as the control unit 20, the storing unit 10, or the like, in an information processing apparatus, such as a known personal computer and a workstation.

The components of each unit illustrated in the drawings are not always physically configured as illustrated in the drawings. In other words, the specific shape of a separate or integrated unit is not limited to the drawings; however, all or part of the unit can be configured by functionally or physically separating or integrating any of the units depending on various loads or use conditions. For example, the grouping unit 21 and the rule extracting unit 22 may also be integrated as a single unit. In contrast, the tag common rule specifying unit 23 may also be separated by dividing it into a processing unit that is used when a design rule that is common in tags can be specified and a processing unit that is used when design rule that is common in tags is not able to be specified. Furthermore, the storing unit 10 may also be stored in an external device of the setting support device 1. Furthermore, the external device that stores therein the storing unit 10 may also be connected to the setting support device 1 via a network.

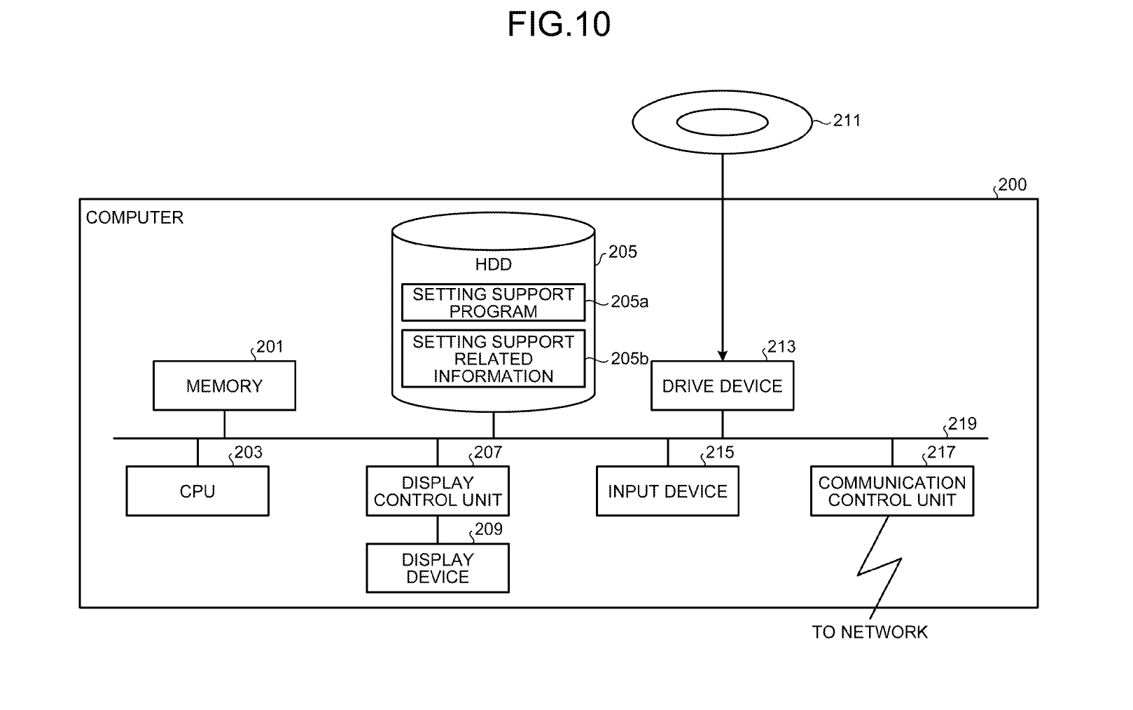

The various processes described in the embodiments can be implemented by a program prepared in advance and executed by a computer such as a personal computer or a workstation. Accordingly, in the following, a computer that executes a setting support program having the same function as that performed by the setting support device 1 illustrated in FIG. 1 will be described. FIG. 10 is a block diagram illustrating an example of a computer that executes a setting support program.

As illustrated in FIG. 10, a computer 200 includes a CPU 203 that executes various arithmetic processing, an input device 215 that receives an input of data from a user, and a display control unit 207 that controls a display device 209. Furthermore, the computer 200 includes a drive device 213 that reads a program from a storage medium and a communication control unit 217 that sends and receives data to and from another computer via a network. Furthermore, the computer 200 includes a memory 201 that temporarily stores therein various kinds of information and an HDD 205. Furthermore, the memory 201, the CPU 203, the HDD 205, the display control unit 207, the drive device 213, the input device 215, and the communication control unit 217 are connected by a bus 219.

The drive device 213 is a device for, for example, a removable disk 211. The HDD 205 stores therein a setting support program 205a and a setting support related information 205b.

The CPU 203 reads the setting support program 205a, loads the program in the memory 201, and then executes the program as a process. The process corresponds to each of the functioning units in the setting support device 1. The setting support related information 205b corresponds to the tag information table 11, the teacher data 12, and the manual input parameter 13. Then, for example, the removable disk 211 stores therein each piece of information, such as the teacher data 12.

Furthermore, the setting support program 205a does not always need to be stored in the HDD 205 from the beginning. For example, the program may be stored in a “portable physical medium”, such as a flexible disk (FD), a CD-ROM, a DVD disk, a magneto-optic disk, or an IC card, that is to be inserted into the computer 200. Then, the computer 200 may read and execute the setting support program 205a from the portable physical medium.

According to an aspect of an embodiment of the setting support program disclosed in the present invention, an advantage is provided in that it is possible to automatically design a system that is not the same as an existing system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium storing therein a setting support program that causes a computer to execute a process comprising:
grouping, for a first system that includes multiple attributes, systems that have common attributes;
extracting, for each group grouped at the grouping, a set rule that is used for environmental setting set in each of the systems on the basis of the environmental setting set in each of the systems belonging to a group;
specifying a set rule that is common in each attribute on the basis of the set rule that is extracted for each group at the extracting and on the basis of the attributes included in the systems belonging to each group; and
creating, by using the set rule that is specified for each attribute at the specifying, a set rule that is associated with multiple attributes included in a second system.

2. The non-transitory computer-readable recording medium according to claim 1, the process further comprises estimating, when a set rule that is common in predetermined attributes is not specified at the specifying, the set rule that is common in predetermined attributes on the basis of a set rule of a group that includes the predetermined attributes, on the basis of a set rule that is common in another attribute that is different from the predetermined attributes included in the group, and on the basis of a set rule that is common in all of the groups.

3. The non-transitory computer-readable recording medium according to claim 1, the process further comprises inputting manually, when a new attribute is included in the multiple attributes that are included in the second system, environmental setting related to the new attribute.

4. The non-transitory computer-readable recording medium according to claim 1, the extracting includes extracting, for each group grouped at the grouping, a set rule that indicates the condition and the definition used for the setting of the parameter that is used for the environmental setting set in each of the systems.

5. A setting support device comprising:
a processor; and
a memory, wherein the processor executes:
grouping, for a first system that includes multiple attributes, systems that have common attributes;
extracting, for each group grouped at the grouping, a set rule that is used for environmental setting set in each of the systems on the basis of the environmental setting set in each of the systems belonging to a group;
specifying a set rule that is common in each attribute on the basis of the set rule that is extracted for each group at the extracting and on the basis of the attributes included in the systems belonging to each group; and
creating, by using the set rule specified for each attribute at the specifying, a set rule that is associated with multiple attributes included in a second system.

6. A setting support method executed by a computer, the method comprising:
grouping, for a first system that includes multiple attributes performed by a computer, systems that have common attributes;
extracting, for each group grouped at the grouping performed by the computer, a set rule that is used for environmental setting set in each of the systems on the basis of the environmental setting set in each of the systems belonging to a group;
specifying, performed by the computer, a set rule that is common in each attribute on the basis of the set rule that is extracted for each group at the extracting and on the basis of the attributes included in the systems belonging to each group; and
creating, performed by the computer by using the set rule that is specified for each attribute at the specifying, a set rule that is associated with multiple attributes included in a second system.
